(19) United States
(12) Patent Application Publication
(10) Pub. No.: US 2026/0038013 A1
(43) Pub. Date: Feb. 5, 2026

(54) AI-POWERED VEHICLE OFFER PLATFORM

(71) Applicant: Sell Your Car, Inc., Carlsbad, CA (US)

(72) Inventors: Kristopher Zecca ROSS, Carlsbad, CA (US); Joseph COHEN, Carlsbad, CA (US); Anthony MONTIERO, Carlsbad, CA (US)

(73) Assignee: Sell Your Car, Inc., Carlsbad, CA (US)

(21) Appl. No.: 19/285,352

(22) Filed: Jul. 30, 2025

Related U.S. Application Data
(60) Provisional application No. 63/679,502, filed on Aug. 5, 2024.

(51) Int. Cl. G06Q 30/0601

(52) U.S. Cl. CPC G06Q 30/0611

(57) ABSTRACT

Systems and methods for generating offers relating to predictive vehicle value data. A system has an offer platform, implemented on at least one processor, configured to output predictive used vehicle data to a subscriber. A database is configured to store transaction data relating to used vehicle transactions. The offer platform includes an engine having a dealer predictive machine learning (ML) tool and generative AI tool. A builder and algorithm is configured to generate and manage an interface that enables a user to segment data. A computer-implemented method for generating offers is provided that includes storing transaction data in a database, and generating, with an offer platform implemented on at least one processor, a predictive used vehicle data for output to a subscriber.

### CROSS-REFERENCE TO RELATED APPLICATIONS

The present application claims the benefit of Provisional Application No. 63/679,502, filed Aug. 30, 2024, incorporated by reference in its entirety herein.

### TECHNICAL FIELD

The technical field relates to computer-implemented machine learning and data analysis.

### BACKGROUND

Computer-implemented technologies have been used to store vehicle data. Dealers have used databases and online platforms to track inventory and display information relating to used vehicles available for sale. However, computer-implemented access to available vehicle data across markets is fragmented and difficult to keep up-to-date. A user interested in purchasing a used vehicle may be required to perform searches and look up on many different dealer websites. This can be cumbersome, cost-prohibitive and slow. Different computer searches of different dealer sites and disparate messages over a network may be required which can consume user time and computing resources. Also, such searches rely on stored vehicle data that can be out-of-date for different dealers at the time of the computer search.

### BRIEF SUMMARY

Computer-implemented systems and methods are disclosed that provide AI powered vehicle offers. In one embodiment an AI-powered vehicle offer platform generates vehicle offers.

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

To easily identify the discussion of any particular element or act, the most significant digit or digits in a reference number refer to the figure number in which that element is first introduced.

FIG. 1 is a diagram of a system in accordance with an embodiment.

FIGS. 2A-2C show a flowchart diagram for a process to support a marketing campaign in accordance with an embodiment.

FIGS. 3A-3B show a flowchart diagram for a process to assist a vehicle seller in obtaining a vehicle value in accordance with an embodiment.

FIGS. 4A-4B illustrate a flowchart diagram for a process to assist a dealer in delivering a vehicle value in accordance with one embodiment.

FIG. 5 illustrates a predictive ML tool in an aspect of the subject matter in accordance with one embodiment.

### DETAILED DESCRIPTION

Embodiments of the present disclosure will now be described in detail with reference to the accompanying Figures. Like elements in the various figures may be denoted by reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

In one aspect, computer-implemented systems and methods are provided for delivering automated offers or vehicle values. An offer platform grants subscribers access to generative artificial intelligence (AI) tools, predictive machine learning (ML) models, and accurate, real-time vehicle value information. Output data can be delivered via a direct application programming interface (API) feed, software components, and/or applications to assist subscribers in creating, analyzing, and delivering automated offers on used vehicles.

In one non-limiting embodiment, a dataset may include all passenger vehicles from the year 2000 to the present in the United States of America. This assists subscribers in creating, analyzing, and delivering accurate real-time used car values based on national, regional, and local considerations. This capability has numerous applications, including automotive retail, banking, insurance, manufacturing, marketing, stock trading, and mergers and acquisitions. These fields require responsive vehicle values to inform profitable operational decision-making when buying, valuing, managing, investing in, and selling used cars.

In one non-limiting feature, an offer made up of an AI-driven vehicle value (also referred to as a predictive vehicle value or an iOffer™ vehicle value) may be output. The offer may be based on a normalized dataset representing an instant offer market. The instant offer market is defined as the market where a customer can get an automated offer from a marketplace or dealer website by inputting their VIN, License Plate, or Year, Make, Model, Miles, and basic condition of their vehicle. The predictive vehicle value may be the likely value a customer would have received as an aggregate of the instant offer market.

A builder (e.g., iOffer™ Builder) may support an interface that enables a user to segment data. First, the interface may illustrate the used car market divided into several segments to help the user make their own used car value to make instant offers utilizing specific adjustments to specific segments within the used car market in the United States of America. The interface may have user-interface elements, such as dials, which allow the user to adjust values in the selected segment. When the user adjusts the interface, the adjustment may be applied to the entire dataset within the segment represented in the interface component. Behind the scenes, the user interface transmits these dealer preferences to the iOffer AI database, which turns the adjustments into an algorithm to be syndicated to external sources via a cloud-based API feed. The output is that all offers for vehicles encompassed in the dealer iOffer algorithm may be as comprehensive as adjusting the iOffer vehicle value (or any other vehicle value selected) for up to every passenger vehicle produced with any amount of miles in any condition from the year 2000 to the present in the United States of America.

In one non-limiting feature, a specific value (e.g., iOffer+™ value) may be used and output that is created by a combination of the iOffer or any selected vehicle value utilized within the platform and an adjustment made by a dealer.

In another feature, a predictive vehicle value (e.g., iOfferAI™ value), which may be considered an AI-recommended vehicle value adjustment indication, may be used to serve as a guide to help a dealer know where a predictive AI tool recommends they should set their dial or builder algorithm.

### System

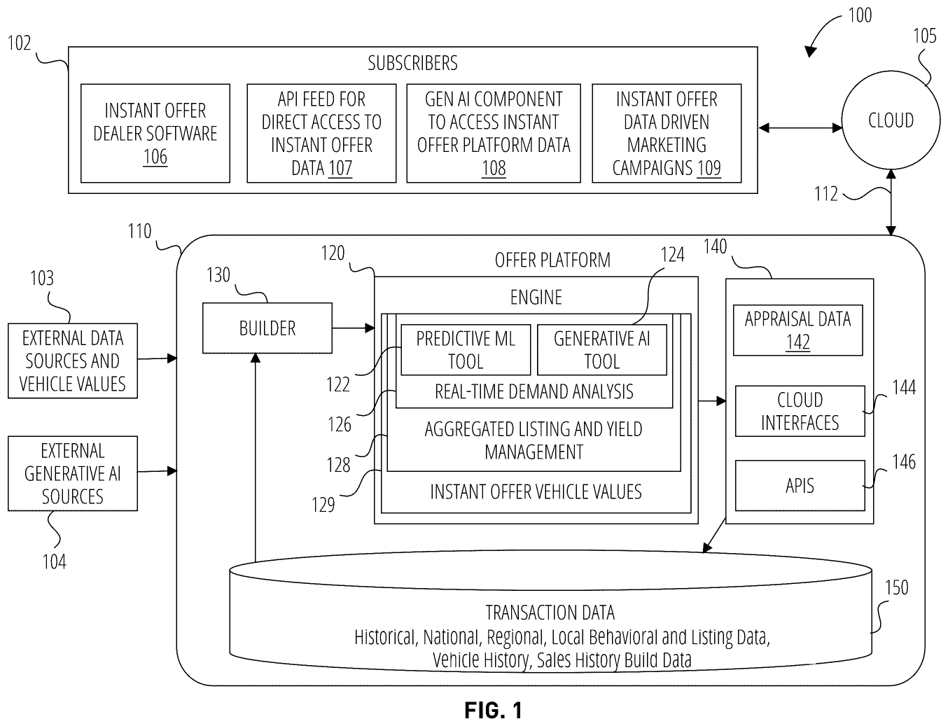

FIG. 1 is a diagram of a computer-implemented system 100 in accordance with one embodiment. System 100 includes an automated offer platform 110. Offer platform 110 allows subscribers 102 to access machine learning and generative AI tools, models, and data delivered via direct API feed. Additionally, offer platform 110 enables software components and applications to assist its subscribers in creating, analyzing, and delivering automated offers on used vehicles.

Offer platform 110 includes an engine 120 that houses a predictive ML tool 122 and a generative AI tool 124. Engine 120 may utilize tool 122 and/or tool 124 to provide real-time demand analysis 126 for vehicles, aggregated listings, yield management 128 for vehicles, and instant offer vehicle values 129. In one embodiment, predictive ML tool 122 employs a trained ML model to predict automotive dealer vehicle and price purchasing behavior. The predicted dealer behavior may be represented as a value indicative of a dealer personality type with respect to used vehicle sales, such as aggressive, systematic, or not systematic. Training data may include dealer personality profile data. In this way, the dealer predictive ML tool 122 can use a trained model to further infer dealer behavior and incorporate the prediction into an output offer or output vehicle value information.

Generative AI tool 124 may be a generative AI tool for creating text and other data to support communications with a user or subscriber. For example, tool 124 may be a customized or private OpenAI tool or another type of generative AI tool that can operate as a chatbot or other agent to communicate with a user or subscriber. Additionally, generative AI tool 124 can generate personalized marketing messages, customer service responses, and detailed vehicle descriptions to enhance user engagement and streamline communication processes.

Platform 110 includes a builder 130 coupled to engine 120. Builder 130 can ingest data from external data sources 103. For example, ingested data may include vehicle values and external generative AI sources 104. Builder 130 is also coupled to database 150 for accessing and outputting transaction data to and from computer-readable storage. In one example, builder 130 may generate and manage an interface that enables a user to segment data. As described above, the interface may illustrate the used car market divided into several segments to help the user create their own used car value to make instant offers by utilizing specific adjustments to specific segments within the used car market in the United States of America.

Platform 110 also includes one or more interfaces 140 for accessing appraisal data 142, and cloud interfaces 144 or APIs 146 to access further data.

Database 150 may be used to store transaction data relating to used vehicle transactions. Such transaction data may include historical, national, regional, and/or local behavioral data, as well as listing data, vehicle history, sales history, and/or build data. In one example, the transaction data may include an iOffer™ dataset that includes all passenger vehicles from the year 2000 to the present in the United States of America.

Output data 112 may be output from offer platform 110 over a network, such as cloud 105, to subscribers 102.

A number of advantages and features are provided in a range of applications. System 100 can help subscribers 102 create, analyze, and deliver accurate real-time used car values based on national, regional, and local considerations. This capability ensures that subscribers have access to the most relevant and up-to-date information, enabling them to make informed decisions. System 100 has many applications across various fields, including automotive retail, banking, insurance, manufacturing, marketing, stock trading, and mergers and acquisitions. By leveraging the system's advanced analytics and predictive tools, these industries can obtain more responsive vehicle values, which inform more profitable operational decision-making. This includes activities such as buying, valuing, managing, investing in, and selling used cars. The system's ability to provide precise and timely data helps businesses optimize their strategies, reduce risks, and enhance overall efficiency in their operations.

In one further embodiment, system 100 is configured to support an email campaign or other type of marketing campaign carried out by an influencer, such as a used car price service or used car aggregator.

In operation, offer platform 110 can be used to provide offers for vehicles in real-time, also referred to as instant offers. Depending on the connectivity and processing speed of user devices, offers may be provided instantly, within milliseconds or seconds. Vehicle values from other value providers can be pushed from external data sources 103 into offer platform 110 and made available directly to other users. Additionally, data from external generative AI sources 104 can also be pushed into offer platform 110.

Builder 130 operates to generate instant offers. In one non-limiting feature, subscribers 102 may include dealers, such as one or more used vehicle dealers across a region, whether within a country, nationwide, or globally. Dealers can create their own instant offer dealer software 106 and syndicate it through data-driven marketing campaigns 109 to their actual or prospective customers. By doing so, dealers can leverage offer platform 110 to create instant offers and push them out in campaigns to their customers.

In one non-limiting feature, dealers can use offer platform 110 to access database 150. Builder 130 can be used to obtain transaction data and market data from database 150 and output it to a dealer, such as by pushing it over to instant offer dealer software 106. The dealer then reviews the received data and creates and applies their own algorithm to generate an instant offer value. Additionally, instant offer dealer software 106 itself can be used as one of the external data sources 103. Indeed, an instant offer from instant offer dealer software 106 gets fed back into engine 120 for further processing. This instant offer may be a vehicle value in an instant offer data format. In this way, one of the data sources that offer platform 110 can use is actually the dealer's instant offer algorithm from its instant offer dealer software 106. Once a dealer has signed off on having a vehicle value in an instant offer format, builder 130 can use that vehicle value as a data point to feed into engine 120.

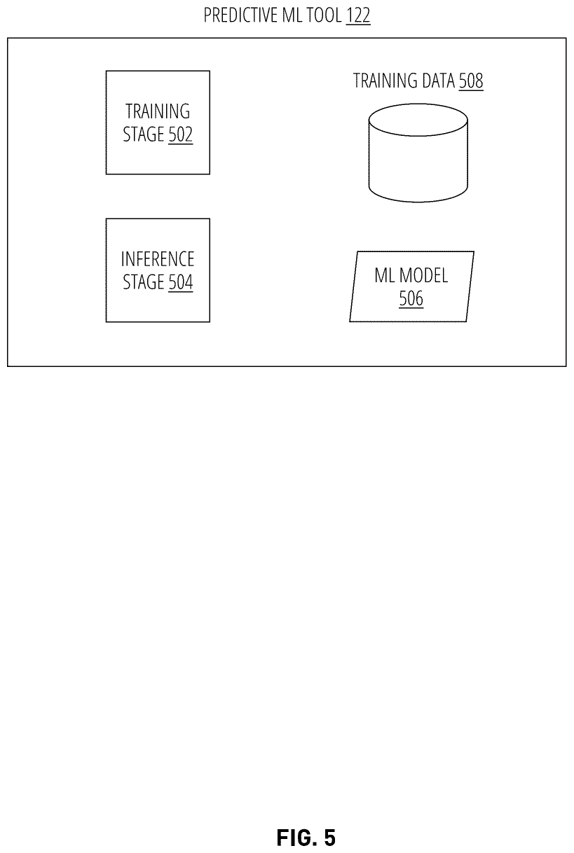

Engine 120 includes a predictive ML tool 122 and a generative AI tool 124. Predictive ML tool 122 can predict the current and future value of a car based on various market analyses and training data. FIG. 5 shows an example of predictive ML tool 122 in further detail. Generative AI tool 124 is configured to create different personas and perform sentiment analysis to assist dealers in buying vehicles. Dealers can use their respective instant offer dealer software 106 to produce accurate sentiment analysis when communicating with customers. Engine 120 can also perform sentiment analysis and use a corresponding dealer persona whenever offer platform 110 is communicating with the dealers in subscribers 102.

In essence, engine 120 can perform real-time demand analysis 126 based on vehicle market conditions for local, regional, or national demand analysis on a year, make, and model basis. Engine 120 can assess the year, make, model, and trim of the vehicle to ensure that the analysis is accurate and that the right suggestions are provided for the cars.

Engine 120 may further determine an aggregated listing and yield management 128. This allows offer platform 110 to figure out the aggregated listing and yield management for a vehicle value. For example, there may be multiple ways to determine the value that a dealer should pay for a car. One method involves determining the retail price of the car, which helps understand the yield or margins. This pricing mechanism may be part of the process used to generate the values for the cars.

iOffer instant offer vehicle values 129 may include both wholesale and retail values. These values are calculated using various metrics and fed back into engine 120. The system manufactures iOffer base values and pushes them to the dealers through builder 130, allowing dealers to create their own iOffer plus values. These plus values are then fed back into engine 120 as well. Thus, there are base values (e.g., number 129) and plus values (e.g., number 130), with the latter being the instant offer algorithm that includes dealer-specific adjustments using the software to make the iOffer value their own.

In non-limiting example, data may be pushed from engine 120 to interfaces 140 for output 112. This can be output 112 over a cloud 105 to subscribers 102. Pushing data from engine 120 to interfaces 140 involves exporting the values. The direct products created from the iOffer values may include appraisal tool appraisal data 142, which allows dealers to book out a car by the number, year, make, and model to determine the car's worth in terms of iOffer vehicle values or third-party vehicle values. As previously mentioned, data from external data sources 103 may be pushed into the iOffer platform and displayed in the appraisal application in 140.

Cloud interfaces 144 provide instances in cloud infrastructure to make all data flowing through these applications scalable and secure.

In one non-limiting feature, system 100 may also include direct APIs 146. Dealers and other data providers may access instances of the platform either by software or by API. Interfaces 140 encompass all instances of this access. The appraisal tool is software, cloud infrastructure provides scalable instances of all products, and the APIs are accessible through APIs 146, available to dealers and data providers.

Information from all of these services is gathered and fed back into database 150, which contains transaction data. The entire ecosystem within offer platform 110 is aggregated and pushed as output 112 to cloud 105, and then offered as external software applications to subscribers 102. Examples of this include the iOffer car dealer software and vehicle values suite. Subscribers can access this data directly via API feed for direct access to instant offer data 107. They can also use the generative AI component to access instant offer platform data 108, which may utilize a large language model to make the database available to consumers and dealers directly via a website. Additionally, market-driven data and instant offer data-driven marketing campaigns 109 can be sent out from the platform to dealers' customers, primarily through email campaigns, text message campaigns, and phone calls.

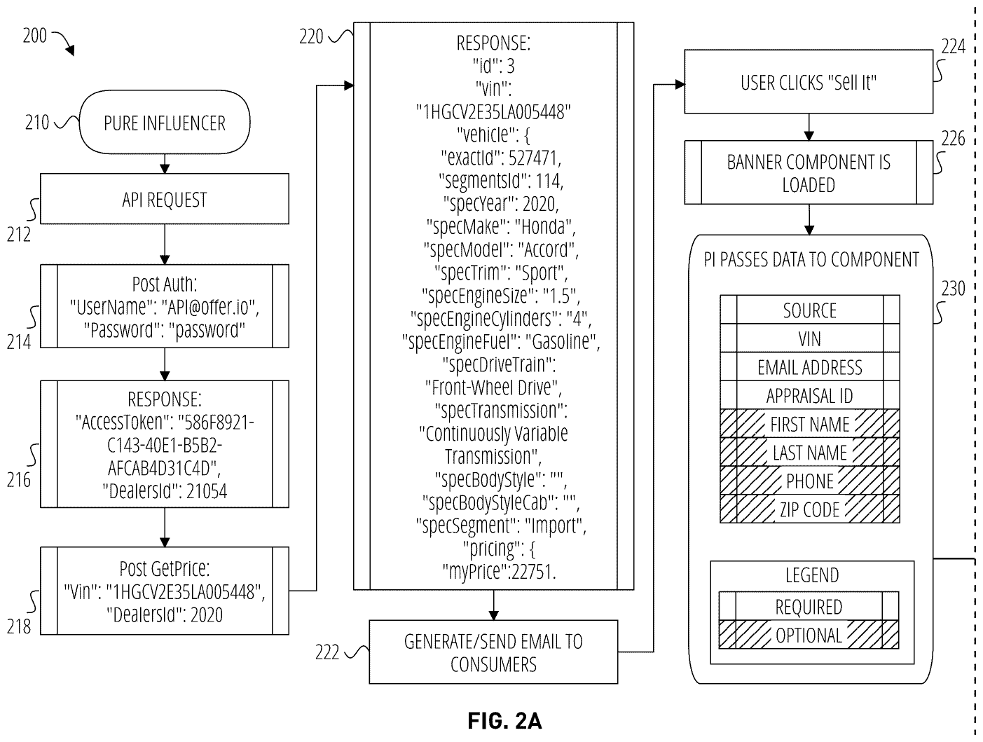

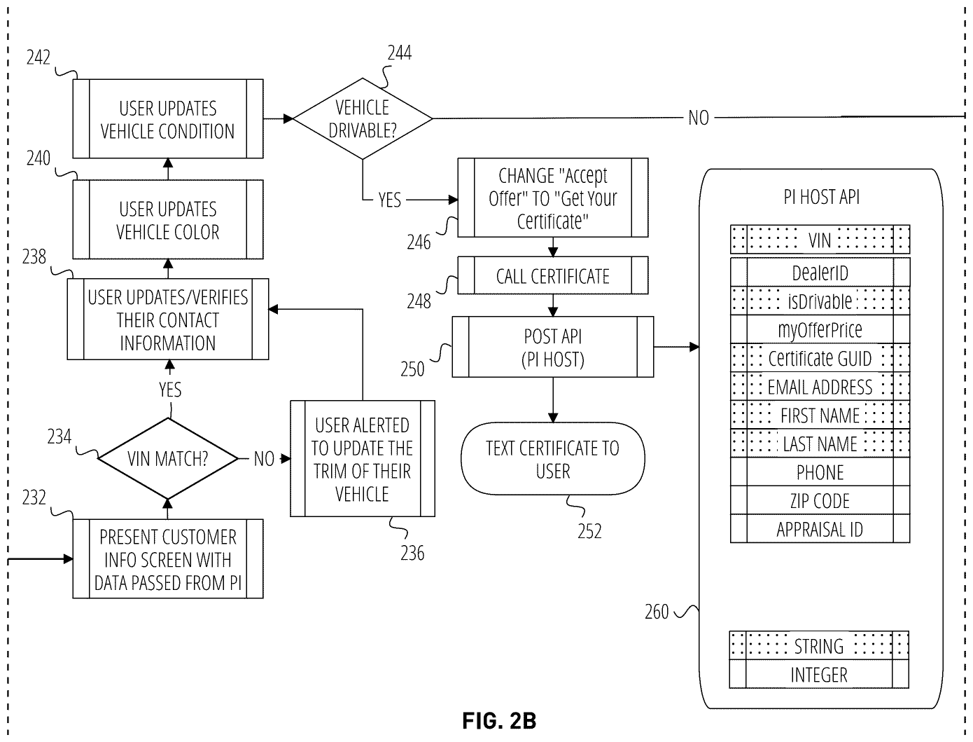

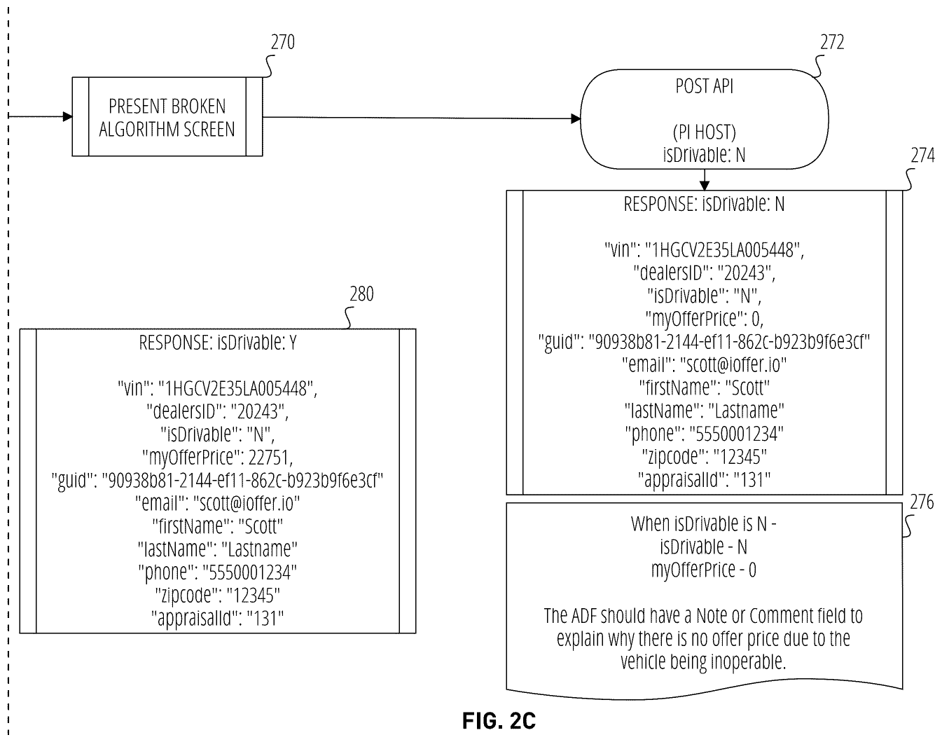

FIGS. 2A-2C are a flowchart diagram for a process 200 to support a marketing campaign with instant offers generated in accordance with an embodiment. In FIG. 2A, process 200 begins with a pure influencer accessing system 100. A pure influencer, for example, may be a subscriber 102 who is a reseller of vehicles. Steps 212-220 show calls and responses to fulfill an API request. In step 212, the reseller makes an API request to offer platform 110. For example, the reseller may have an instant offer dealer software 106 that makes the API request over a network, such as cloud 105. Offer platform 110 receives the API request and processes it. Steps 214, 216, 218, and 220 show the API call and response in further detail. In step 214, instant offer dealer software 106 generates a post with authentication information. In one example, the authentication information includes a reseller username and password information for an API (“API@offer.io”) managed by offer platform 110. In step 216, platform 110 generates a response that includes an access token and the reseller's dealer identification (ID) data. In step 218, instant offer dealer software 106 of the reseller posts a price request for a vehicle. The post may include a get price command, vehicle identification number (VIN), and dealer ID number of a dealer currently offering the vehicle. In step 220, platform 110 generates a response to fulfill the get price post of step 218. As shown in FIG. 2A, the response may include information from a dealer on offer platform 110 corresponding to the requested vehicle (VIN), including an ID value, VIN, exactID, segmentsID, vehicle characteristics data such as year, make, model, trim, engine size, number of cylinders, fuel type, drive train, transmission, body style, market segment, and pricing data. In this way, in one example where a vehicle is a used car, a reseller can call an API managed by offer platform 110 and ask for a value on the car. The reseller may identify the kind of car of interest, and platform 110 provides the details and values of the car.

Once the reseller receives the response in step 220, the reseller may initiate a marketing campaign. In one embodiment, reseller may use software to carry out instant offer data driven marketing campaigns 109. In step 222, an email, text or other type of message is generated and sent to consumers. The email may include an offer for the vehicle referenced in the response of step 220. A user at a remote device that receives the message may click sell it. A banner component is loaded (step 226). An API then passes further data to the loaded component (step 230). The passed data may include source, VIN, email address and appraisal ID information. The passed data may also include first name, last name, and contact information (phone, zip code). Data for a legend may also be passed including a bit flag indicating whether the legend is required or optional.

Control then passes to step 232 shown in FIG. 2B. A customer is presented with a customer info screen and data is passed from a provider. Offer platform 110 checks for VIN match (step 234). If yes, the VIN number matches, then control proceeds to request any updates for user contact information (step 238), vehicle color (step 240), and vehicle condition (step 242). If not, there is no VIN match in step 234, and a user is alerted in step 236 to go match the trim on the vehicle. Once the alert is issued, control proceeds back to step 238 so the user can update their profile information (e.g., contact information). In some cases, control also checks if the vehicle is drivable (step 244). If yes, a status change from “Accept Offer” to “Get Your Certificate” is made and the user notified. (step 246).

In one implementation, this process flow chart shows how a lead travels through a marketing campaign using offer platform 110. For example, to set up a marketing campaign as a third-party lead provider, one can use offer platform 110 via an API request. The provider sends the request, receives the information back, and then sends an email to the customer. The customer receives the email and proceeds through the process outlined in steps 238, 240, and 242. These steps include all the questions that the customer is asked.

And then after all of that, system 100 may end up making a certificate (step 248). This certificate is an offer to buy the vehicle. In step 250, the certificate may be posted through a PI host API back to system 100, allowing the customer's certificate to remain available for some time. This ensures that it can be referenced at any other point in time if needed. The posted certificate in step 250 can include certificate information shown in an example post data 260, which may consist of VIN, dealer ID, drivable or not flag, my offer price, certificate GUID, email address, first name, last name, phone number, zip code, and appraisal ID. A legend string or integer can also be posted.

If the vehicle is drivable, a response may be sent (step 280). The response may include a drivable Y flag, VIN, dealer ID, offer price, GUID, contact information (email, last name, first name, phone, zip code), and appraisal ID. If the vehicle is not drivable, a broken screen may be presented (step 270), and a not drivable response may be made (step 272). The not drivable response shown in step 274 may include a not drivable flag (N) and other information (steps 274, 276). The not drivable response may include a drivable N flag, VIN, dealer ID, offer price, GUID, contact information (email, last name, first name, phone, zip code), and appraisal ID, along with a comment indicating no price offered due to the vehicle being inoperable.

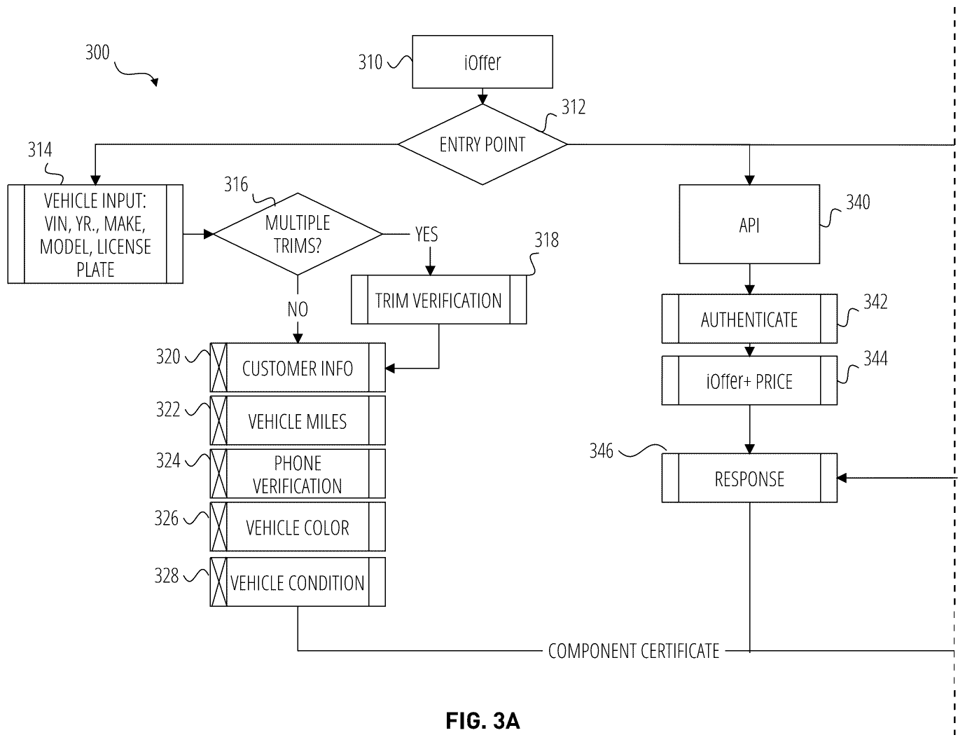

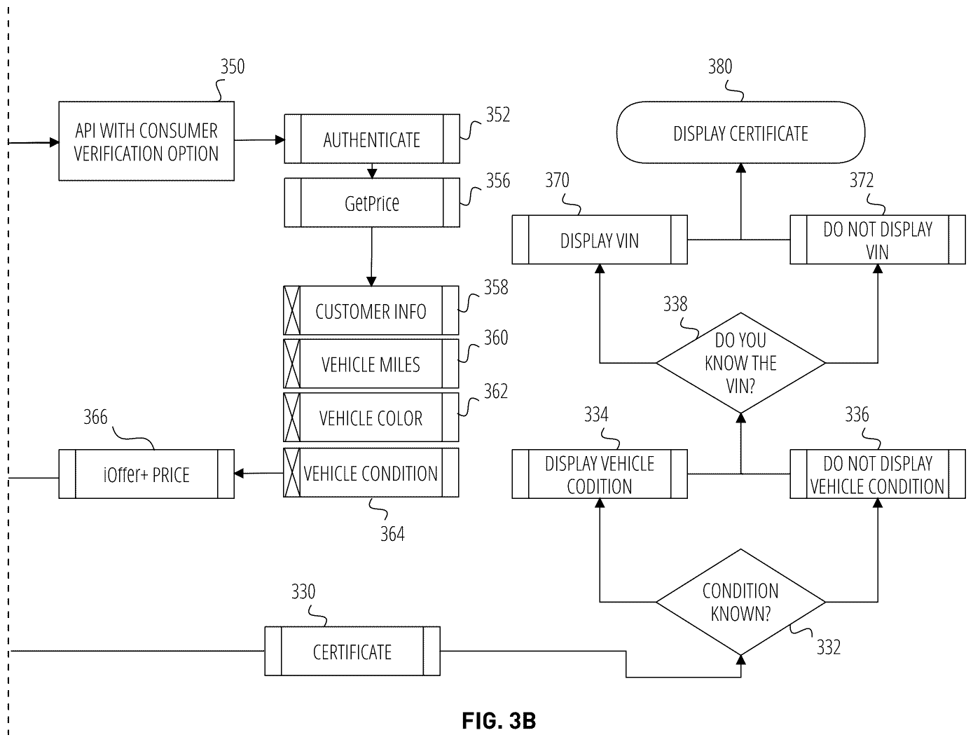

FIGS. 3A-3B show a flowchart diagram for a process 300 to assist a vehicle seller in obtaining a vehicle value in accordance with an embodiment (steps 310-380). In step 310, a request for a vehicle value in an instant offer is made to offer platform 110. For example, a person may wish to get an instant offer for the value of a vehicle they wish to sell. This request may be made in different ways. In one case, requests may be made through internet leads provided by a subscribers 102. For example, a dealer may add a widget to their website enabling a customer to request a vehicle value for a car they wish to sell. In other example, a dealer may enable a customer to make a request through their instant offer dealer software 106.

A customer using a remote device having a browser can select the widget on the dealer website to request a vehicle value (step 312). Steps 314-332 show a process that the customer would take in order to get a vehicle value and instant offer on their car through the widget on the dealer's website. The instant offer includes a certificate. The widget communicating with offer platform 110 solicits and collects vehicle information from the customer through one or more prompts. In step 314, the customer inputs vehicle information (VIN, year, make, model and license plate number.) Offer platform 110 receives the vehicle information and checks whether multiple trims exist for type of vehicle (step 316). If yes, an additional prompt is sent to customer to verify which trim is associated with the vehicle (step 318). If no multiple trims exist or if the customer has identified a particular trim, control proceeds to obtain further information including customer information (step 320), vehicle mileage (step 322), phone number verification (step 324), vehicle color (step 326), and vehicle condition (step 328). Vehicle condition may be one or more conditions indicative of wear or defects, such as, the four primary categories, Excellent, Good, Fair, and Poor used by Kelley Books for used vehicles.

Control then proceeds to obtain a certificate as shown in FIG. 3B. For example, the widget may ask a customer if they wish to obtain a certificate (step 330). If yes, then the customer is asked if the vehicle condition is known (step 332). If yes, the vehicle condition is flagged to be displayed in the certificate (step 334); if no, the vehicle condition is flagged to not be displayed in the certificate (step 336). In step 338, the customer is asked if the VIN is known. If yes, the VIN is flagged to be displayed in the certificate (step 370); if no, the VIN is flagged to not be displayed in the certificate (step 372). In step 380, the completed certificate is then displayed to the customer.

Other entry points to obtain an instant offer price from offer platform 110 are through the use of an API (step 340) or an API with consumer verification (step 350). A dealer website widget or instant offer dealer software 106 may communicate with offer platform 110 through an API. In this way, a customer may first be authenticated (such as with a username password) (step 342). A request is then generated for an instant offer with price (step 344). Offer platform 110 then returns a response having an instant offer including a price for the customer's vehicle (step 346).

As further shown in FIG. 3B, in step 350, a dealer website widget or instant offer dealer software 106 may communicate with offer platform 110 through an API with customer (consumer) verification. A customer may first be authenticated (such as with a username password) (step 352). A request is then generated to request price from offer platform 110 (step 356). Further verification steps (steps 358-364) are carried out about the customer and vehicle before an instant offer including a price for the customer's vehicle is generated. These steps may include obtaining and verifying customer information (step 358), vehicle mileage (step 360), vehicle color (step 362), and vehicle condition (step 364). Offer platform 110 then returns a response having an instant offer including a price for the customer's vehicle (step 366). In this way, a customer is able to get a price for their vehicle from offer platform 110 using the API and customer verification option.

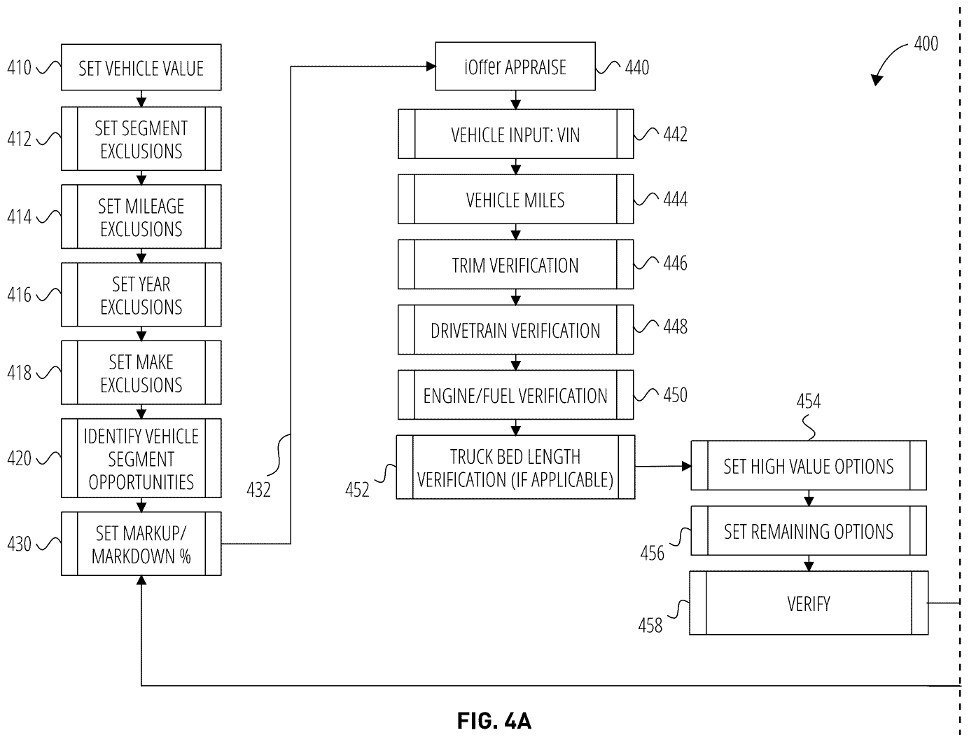

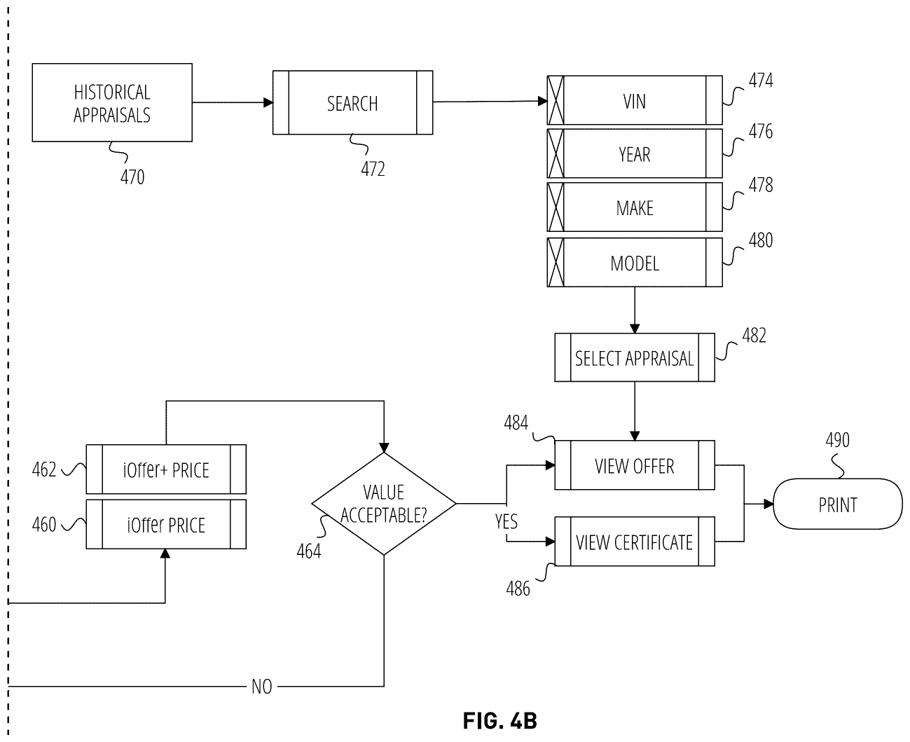

FIGS. 4A-4B illustrate a flowchart diagram for a process 400 to assist a dealer in delivering a vehicle value in accordance with one embodiment (steps 410-490). Consider an example of a dealership vehicle that the dealer plans to offer for sale. The dealer wishes to find vehicles for purchase and eventual resell. A dealer may also wish to obtain an iOffer appraisal price to make sure vehicles they are offering are consistent with historical appraisals.

First, a dealer communicates with offer platform 110. For example, a dealer may use instant offer dealer software 106 to communicate with an API that accesses offer platform 110. The first set of steps 410-430 enable a dealer to set which vehicles are sought to be priced. Instant offer dealer software 106 enables the dealer to set a vehicle value of a vehicle being sought or appraised (step 410). Instant offer dealer software 106 through an API call further may enable a dealer to identify or input different exclusions to winnow what vehicles are being considered. For example, a dealer may set one or more of segment exclusions (step 412), mileage exclusions (step 414), year exclusions (step 416), and make exclusions (step 418). For example, in step 412 the dealer may provide information on segment exclusions which pertain to a vehicle type or look (such as, import or domestic, vehicle condition, or manufacturer or model). In step 414, the dealer may also set any cars they don't like with excessive mileage (for example a dealer may not wish to bid on any cars over 150,000 miles). Other exclusions may be set like a value or range of values for year of manufacture (step 416) or particular vehicle make(s) (step 418). In step 420, a dealer may be able to identify a vehicle segment opportunity. This may involve asking a query of offer platform 110 of the types of available segments so that a dealer may further exclude undesired segments akin to turning dials to tune to a segment of interest. Finally, a dealer may also set a markup or markdown percentage that they are willing to abide by for an offer price. This can be, for example, ten or twenty percent of an instant offer appraisal price to be determined.

The second set of steps 440-462 in process 400 relate a sub-process for generating an instant offer appraisal price for a vehicle. Additional steps 464-490 relate to further comparisons of an instant offer price with historical appraisals and making the instant offer and an accompanying certificate available for output.

Steps 410-430 produce output 432, which can be used to carry out an instant offer appraisal (step 440). Output 432 can be the set vehicle value, exclusions, and markup/markdown value provided by dealer. This output 432 can be sent as a bid for an appraisal. In step 440, an instant offer appraisal is initiated. This allows the requesting dealer to compare a vehicle price against other vehicle prices managed by offer platform 110.

In steps 442-452, a dealer can input appraisal data, that is, specific data about a vehicle being appraised. This includes inputting a VIN (step 442), mileage (step 444), trim verification (step 446), drive train verification (step 448), engine/fuel verification (step 450), and truck bed length verification (step 452). A dealer can set high value options (step 454) and other remaining options (step 456). A verification of the appraisal data is made (step 458).

Control proceeds to generate an instant offer price (460) and/or an instant offer plus price (step 462).

In step 464, an instant offer price or instant offer plus price are compared with similar historical appraisals to determine if the prices generated in steps 460-462 are acceptable. If yes, the instant offer with price or instant offer plus price are output for viewing (step 484) along with a certificate (step 486). A dealer may also elect to print (or transmit) the instant offer and/or certificate (step 490). If no, a vehicle value is not acceptable in step 464, control proceeds to step 430 for further evaluation with an acceptable markup or markdown.

“essential” and the like

FIG. 5 shows a predictive ML tool 122. Predictive ML tool 122 includes a Training Stage 502 and an Inference Stage 504. Training Stage 502 uses Training Data 508 to train an ML Model 506. Inference Stage 504 receives input data and applies the trained ML model to obtain a predictive value. The predictive ML tool 122 leverages machine learning models to identify and analyze relationships between various parameters, such as vehicle characteristics and market conditions, to predict vehicle values. By simulating interconnected processing units arranged in layers, the model can adjust its weights based on historical data and previous executions, thereby refining its accuracy over time. For example, the ML tool 122 might analyze data from thousands of past vehicle sales during the Training Stage 502 to train an ML model, including in its analysis factors like make, model, year, mileage, and regional market trends. The ML tool 122 may then apply the trained ML at the Inference Stage 504

In on non-limiting example, the ML tool 122 may be tasked with predicting the current market value of a 2015 Zephyr X200 with 60,000 miles in the Midwest region. The Training Stage 502 may feed the ML model historical sales data, including similar vehicles' sale prices, economic indicators, seasonal trends, and regional demand fluctuations. The model would learn to recognize patterns and correlations, such as how mileage impacts value differently in urban versus rural areas or how certain makes and models depreciate over time. Learning may be performed by comparing training data to reference data, and adjusting the weights of the ML model accordingly. During the Inference Stage 504, the ML model may receive the input data for a specific 2015 Zephyr X200. Inference Stage 504 may process this data through its trained layers, each layer applying learned weights to the input features (e.g., year, make, model, mileage, region). In one example, the ML model might use regression techniques to estimate the vehicle's value, considering the learned relationships from the training data. The output is a predictive value that reflects the current market conditions and the specific attributes of the vehicle. This process allows the system to provide precise and reliable vehicle valuations, which can be utilized by dealers and other subscribers to make informed decisions regarding buying, selling, and managing vehicle inventories. The continuous learning capability of the ML model keeps the predictions relevant and up-to-date with changing market trends.

As used herein, the term “machine learning model” can refer to a computer model used to facilitate one or more machine learning tasks (e.g., regression and/or classification tasks). For example, a machine learning model can represent relationships (e.g., causal or correlation relationships) between parameters and/or outcomes within the context of a specified domain. For instance, machine learning models can represent the relationships via probabilistic determinations that can be adjusted, updated, and/or redefined based on historic data and/or previous executions of a machine learning task. In various aspects described herein, machine learning models can simulate a number of interconnected processing units that can resemble abstract versions of neurons. For example, the processing units can be arranged in a plurality of layers (e.g., one or more input layers, hidden layers, and/or output layers) connected by varying connection strengths (e.g., which can be commonly referred to within the art as “weights”).

Machine learning models can learn through training with one or more training datasets; where data with known outcomes input into the machine learning model, outputs regarding the data are compared to the known outcomes, and/or the weights of the machine learning model are autonomously adjusted based on the comparison to replicate the known outcomes. As the one or more machine learning models train (e.g., utilize more training data), the machine learning models can become increasingly accurate; thus, trained machine learning models can accurately analyze data with unknown outcomes, based on lessons learned from training data and/or previous executions, to facilitate one or more machine learning tasks.

Example types of machine learning models can include, but are not limited to: artificial neural network (“ANN”) models, Bayesian neural network (“BNN”) perceptron (“P”) models, feed forward (“FF”) models, radial basis network (“RBF”) models, deep feed forward (“DFF”) models, recurrent neural network (“RNN”) models, long/short memory (“LSTM”) models, gated recurrent unit (“GRU”) models, auto encoder (“AE”) models, variational AE (“VAE”) models, denoising AE (“DAE”) models, sparse AE (“SAE”) models, markov chain (“MC”) models, Hopfield network (“HN”) models, Boltzmann machine (“BM”) models, deep belief network (“DBN”) models, convolutional neural network (“CNN”) models, deep convolutional network (“DCN”) models, deconvolutional network (“DN”) models, deep convolutional inverse graphics network (“DCIGN”) models, generative adversarial network (“GAN”) models, liquid state machine (“LSM”) models, extreme learning machine (“ELM”) models, echo state network (“ESN”) models, deep residual network (“DRN”) models, kohonen network (“KN”) models, support vector machine (“SVM”) models, and/or neural turing machine (“NTM”) models.

### Example System Implementations

System 100, including offer platform 110, may be implemented on one more computing devices coupled over one or more data networks. A computing device can be any electronic computing device. A user can enter control inputs through a user interface (such as a keyboard, microphone, or touchscreen). For example, a computing device can include, but is not limited to, a mobile computing device (such as a smartphone or tablet computer), wearable computing device (such as a smart watch or headset), a desktop computer, laptop computer, set-top box, smart television, smart display screen, kiosk, or other type of computing device having at least one processor and computer-readable memory. In addition to at least one processor and memory, such a computing device may include software, firmware, hardware, or a combination thereof. Software may include one or more applications, a browser, and an operating system. Hardware can include, but is not limited to, a processor, memory, display or other input/output device. A communication interface and transceiver can be included to perform data communication (wired or wireless) over a data network.

A data network or may be any type of data network or combination of data networks, including but not limited to, a local area network, medium area network or wide area network, such as, the Internet.

Offer platform 110 may also be implemented on one or more servers, as a single server or part of a group of servers. One or more servers may include one or more processors and computer-readable memory and can be distributed at the same or different locations. Web servers may also be included and coupled to servers or part of servers to support operations and enable communications (through Web protocols and networking layers) between the platform and browsers on remote computing devices.

Application programming interfaces (APIs) may also be used to call different services and functions to distribute aspects of the functions of system 100 and each of its components (engine 120, builder 130, and interfaces 140) on different computing devices over a data network.

### Additional Processor-Implemented Embodiments and Example Implementations

Aspects of the embodiments for exemplary system 100, including offer platform 110 and its components engine 120, builder 130, and interfaces 140, may be implemented electronically using hardware, software modules, firmware, tangible computer readable or computer usable storage media having instructions stored thereon, or a combination thereof and may be implemented in one or more computer systems or other processing systems at the same location or different locations. Example computing devices that may be used by users include, but are not limited to, a mobile computing device (such as a smartphone or tablet computer), a desktop computer, laptop computer, set-top box, smart television, smart display screen, kiosk, or other type of computing device having at least one processor and computer-readable memory. In addition to at least one processor and memory, such a computing device may include software, firmware, hardware, or a combination thereof. Software may include one or more applications, a browser, and an operating system. Hardware can include, but is not limited to, a processor, memory, display or other input/output device.

Embodiments may be directed to computer products comprising software stored on any computer usable medium such as memory. Such software, when executed in one or more data processing device, causes a data processing device(s) to operate as described herein.

In an embodiment, offer platform 110 may be implemented in an architecture distributed over one or more networks, such as, for example, a cloud computing architecture. Cloud computing includes but is not limited to distributed network architectures for providing, for example, software as a service (SaaS), infrastructure as a service (IaaS), platform as a service (PaaS), network as a service (NaaS), data as a service (DaaS), database as a service (DBaaS), backend as a service (BaaS), test environment as a service (TEaaS), application programming interface as a service (APIaaS), or an integration platform as a service (IPaaS).

Storage database 150 for example may be a database platform running database management software available from an organization such as a commercial vendor or open source community.

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware. Furthermore, portions of the embodiments may be a computer program product on a computer-usable storage medium having computer readable program code on the medium. Any non-transitory, tangible storage media possessing structure may be utilized including, but not limited to, static and dynamic storage devices, hard disks, optical storage devices, and magnetic storage devices, but excludes any medium that is not eligible for patent protection under 35 U.S.C. § 101 (such as a propagating electrical or electromagnetic signal per se). As an example and not by way of limitation, a computer-readable storage media may include a semiconductor-based circuit or device or other integrated circuit (IC) (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, where appropriate.

Certain embodiments have also been described herein with reference to block illustrations of methods, systems, and computer program products. It will be understood that blocks of the illustrations, and combinations of blocks in the illustrations, can be implemented by computer-executable, or machine-readable, instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

“Real-time” may refer to the capability of a system or process to respond to inputs or events within a strict period of time, such as immediately or within seconds or milliseconds. In computing and information technology, real-time systems may be designed to process data and provide outputs instantaneously or almost instantaneously, ensuring minimal latency.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A system, comprising:
an offer platform, implemented on at least one processor, configured to output predictive used vehicle data to a subscriber; and
a database, coupled to the offer platform, configured to store transaction data relating to used vehicle transactions.

2. The system of claim 1, wherein the offer platform enables a subscriber to access machine learning and generative AI tools and models and data delivered via direct API feed, software components and/or applications to help subscribers create, analyze and/or deliver automated offers on used vehicles.

3. The system of claim 1, wherein the offer platform includes an engine having a predictive machine learning (ML) tool and generative AI tool.

4. The system of claim 1, wherein the offer platform includes a builder and algorithm coupled to engine, wherein the builder is configured to generate and manage an interface that enables a user to segment data, whereby, the interface may illustrate the used car market divided into several segments to help the user make their own used car value to make instant offers utilizing specific adjustments to specific segments within the used car market in the United States of America.

5. A computer-implemented method for generating offers, comprising:
storing transaction data in a database;
generating, with an offer platform implemented on at least one processor, a predictive used vehicle data for output to a subscriber.
